(19) United States
(12) Patent Application Publication
(10) Pub. No.: US 2012/0103022 A1
(43) Pub. Date: May 3, 2012

(54) CRUCIBLE ASSEMBLY FOR MANUFACTURING SILICON INGOT INCLUDING SUBSIDIARY CRUCIBLE

(75) Inventors: Young Jo Kim, Gimpo-si (KR); Young Kwan Kim, Seoul (KR)

(73) Assignee: INSOTEQ CO., LTD., Incheon (KR)

(21) Appl. No.: 13/378,861

(22) PCT Filed: Jun. 16, 2010
(86) PCT No.: PCT/KR10/03881

§ 371 Date: Dec. 16, 2011

(30) Foreign Application Priority Data
Jun. 18, 2009 (KR) 10-2009-0054519

(51) Int. Cl. C03B 19/02

(52) U.S. Cl. 65/361

(57) ABSTRACT

The present invention relates to a crucible assembly for manufacturing a silicon ingot including a subsidiary crucible, and, more particularly, to a crucible assembly for manufacturing a silicon ingot including a subsidiary crucible, which is used in an apparatus for manufacturing a silicon ingot by refining a silicon raw material, and which can manufacture a silicon ingot having a high effective height because it includes a standard crucible and a subsidiary crucible so that it can be charged with a large amount of silicon raw material. The crucible assembly for manufacturing a silicon ingot includes: a standard crucible which melts a silicon raw material and whose upper portion is opened; a standard crucible supporter which surrounds the standard crucible to position the standard crucible in place; a subsidiary crucible including open upper and lower portions, which is provided at a bottom thereof with an inclined surface and which has a size smaller than that of the standard crucible, the inclined surface being in contact with the upper surface of the standard crucible; and a subsidiary crucible supporter which surrounds the subsidiary crucible to position the subsidiary crucible in place.

### TECHNICAL FIELD

The present invention relates to a crucible assembly for manufacturing a silicon ingot including a subsidiary crucible, and, more particularly, to a crucible assembly for manufacturing a silicon ingot including a subsidiary crucible, which is used in an apparatus for manufacturing a silicon ingot by refining a silicon raw material, and which can manufacture a silicon ingot having a high effective height because it includes a standard crucible and a subsidiary crucible and is thus charged with a large amount of silicon raw material.

### BACKGROUND ART

A silicon ingot manufacturing apparatus is an apparatus for manufacturing a silicon ingot used to make a silicon wafer. As shown in FIG. 3, a silicon ingot manufacturing apparatus includes a crucible 10 made of quartz or graphite, a crucible supporter 20 surrounding the crucible 10 to set the position of the crucible 10, and heaters 30 surrounding the crucible supporter 20. Further, the apparatus may be configured such that a cooling plate 40 necessary for cooling the crucible 10 is disposed under the crucible 10, and a crucible base 50, a heater 30 and an insulating plate 60 are disposed between the crucible and the cooling plate 40.

These components are disposed in a closed vacuum chamber 70 to manufacture a silicon ingot.

Hereinafter, a method of manufacturing a silicon ingot will be briefly described. First, the crucible 10 is charged with a silicon raw material 80, and is then heated by the heaters 30 surrounding the crucible supporter 20 to melt the silicon raw material. When the silicon raw material charged in the heated crucible 10 is melted, the heaters 30 are turned off, and then the crucible 10 comes into contact with the cooling plate 40, so that silicon is recrystallized by directional solidification, thereby manufacturing a silicon ingot.

The silicon ingot manufactured in the crucible is used after cutting predetermined upper and lower portions thereof. In this case, during the recrystallization process for manufacturing a silicon ingot, the crucible is damaged by the difference in thermal expansion coefficient between the crucible and the silicon raw material, so that the crucible cannot be reused, with the result that the crucible must be replaced for each work. Further, since the manufactured silicon ingot must be used after a predetermined portion thereof has been cut, there is a problem in that the thickness of the silicon ingot is limited depending on the effective height of the silicon ingot.

Further, when the particle size of the powdered silicon raw material is large, its porosity increases, so that the crucible is charged with low-density silicon raw material, and thus the amount of the silicon raw material charged in the crucible is limited. Therefore, as shown in FIG. 3, there is a problem in that the number of silicon wafers which can be produced at once decreases because the height (h) of a silicon ingot manufactured using a low-density silicon raw material is lower than the height (H) of a silicon ingot manufactured using a standard silicon raw material.

Although a crucible having a high height can be used in order to solve the above problems, this high crucible is also problematic in that it takes a lot of money to manufacture a silicon ingot and in that it is difficult to manufacture a silicon ingot.

### DISCLOSURE

### Technical Problem

Accordingly, the present invention has been devised to solve the above-mentioned problems, and an object of the present invention is to manufacture a silicon ingot having a high effective height for each work using a crucible assembly for melting a silicon raw material, the crucible being provided thereon with a subsidiary crucible.

Another object of the present invention is to reduce the cost required to replace a crucible, a crucible being replaced as a result of the crucible having been damaged during the procedure of cooling the molten silicon raw material used to manufacture a silicon ingot.

Still another object of the present invention is to prevent the molten silicon raw material from flowing down to the outside of a crucible at the time of manufacturing a silicon ingot.

### Technical Solution

In order to accomplish the above objects, an aspect of the present invention provides a crucible assembly for manufacturing a silicon ingot, which is used in an apparatus for manufacturing a silicon ingot by refining a silicon raw material, including: a standard crucible which melts a silicon raw material and whose upper portion is opened; a standard crucible supporter which surrounds the standard crucible to position the standard crucible in place; a subsidiary crucible including open upper and lower portions, which has length and width smaller than those of the standard crucible, the inclined surface being in contact with the upper surface of the standard crucible; and a subsidiary crucible supporter which surrounds the subsidiary crucible to position the subsidiary crucible in place.

### Advantageous Effects

The present invention is advantageous in that, in a silicon ingot manufacturing apparatus, a crucible is provided thereon with a subsidiary crucible, and thus a greater amount of a silicon raw material is charged in the crucible, so that a silicon ingot having a high effective height can be manufactured for each work even when a low-density silicon raw material as well as a standard silicon raw material is used, and also in that the cost required to replace a crucible, a crucible being replaced as a result of damage that occurred to the crucible during the procedure of cooling the molten silicon raw material used to manufacture a silicon ingot, can be reduced.

Further, the present invention is advantageous in that the inner width of a subsidiary crucible is smaller than that of a standard crucible, and the inclined surface of a subsidiary crucible coming into contact with the upper surface of a standard crucible prevents the molten silicon raw material from flowing down to the outside of the standard crucible along the wall thereof to collect the molten silicon raw material in the standard crucible, thereby manufacturing a silicon ingot having a high effective height.

### DESCRIPTION OF DRAWINGS

FIG. is a sectional side view of a crucible assembly for manufacturing a silicon ingot according to the present invention.

FIG. 2 is a plan view of a subsidiary crucible.

FIG. 3 is a sectional side view of a silicon ingot manufacturing apparatus including a conventional crucible.

### DESCRIPTION OF THE REFERENCE NUMERALS IN THE DRAWINGS

100: standard crucible

110: standard crucible supporter

120: standard crucible base

130: upper surface of standard crucible

200: subsidiary crucible

210: subsidiary crucible supporter

220: sectional surface of subsidiary crucible

230: lower inclined surface of subsidiary crucible

H: height of silicon ingot manufactured using standard silicon raw material

h: height of silicon ingot manufactured using low-density standard silicon raw material

### Best Mode

Hereinafter, preferred embodiments of a crucible assembly for manufacturing a silicon ingot including a subsidiary crucible according to the present invention will be described in detail with reference to the accompanying drawings.

In the following description of the present invention, when it is determined that the detailed description of the related art would obscure the gist of the present invention, the description thereof will be omitted. Further, the following terms, which are defined in consideration of functions of the present invention, may be altered depending users' intentions or judicial precedents. Therefore, the meaning of each term should be interpreted based on the content of the entire present specification.

First, the crucible assembly for manufacturing a silicon ingot, which is used in an apparatus for manufacturing a silicon ingot by refining a silicon raw material, includes: a standard crucible which melts a silicon raw material and whose upper portion is opened; a standard crucible supporter which surrounds the standard crucible to position the standard crucible in place; a subsidiary crucible including open upper and lower portions, which is provided at a bottom thereof with an inclined surface and which has length and width smaller than those of the standard crucible, the inclined surface being in contact with the upper surface of the standard crucible; and a subsidiary crucible supporter which surrounds the subsidiary crucible to position the subsidiary crucible in place.

Here, the inclined surface of the subsidiary crucible may be inclined at an angle of 3˜7° to a horizontal plane toward the inside of the subsidiary crucible.

Further, the lateral side of the subsidiary crucible may be spaced apart from the lateral side of the subsidiary crucible supporter by 1˜10 mm.

Furthermore, the subsidiary crucible may be any one of an integrated crucible and a detachable crucible.

Hereinafter, a preferred embodiment of the present invention will be described in more detail. However, the following embodiment is set forth to illustrate the present invention, and the scope of the present invention is not limited thereto.

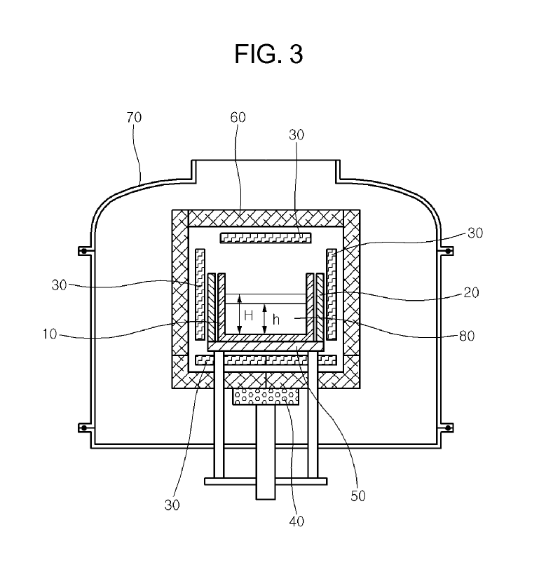

FIG. 1 is a sectional side view showing a crucible assembly including a standard crucible 100 and a subsidiary crucible 200 disposed on the standard crucible 100. Heaters, an insulating plate, a cooling plate and the like are not shown in FIG. 1 because they are shown in FIG. 3.

As shown in FIG. 1, the crucible assembly for manufacturing a silicon ingot includes: a standard crucible 100 made of quartz or graphite; a standard crucible supporter 110 surrounding the standard crucible 100 to position the standard crucible 100 in place; and a standard crucible base 120 disposed beneath the standard crucible 100.

All of the standard crucible supporter 110, standard crucible base and the following subsidiary crucible 200 and subsidiary crucible supporter 210 are made of graphite or graphite coated with another material, and thus they exhibit high thermal conductivity when they are heated by heaters or are cooled by a cooling plate.

The standard crucible supporter 110 is not combined and fixed with the standard crucible 100, and functions to place the standard crucible 100 at an original position at the time the standard crucible 100 is replaced and to prevent the pieces of the standard crucible 100 from scattering outwards, the pieces being produced when the standard crucible 100 is damaged in the course of cooling and recrystallizing the molten silicon raw material at the time of manufacturing a silicon ingot.

The lateral side of the standard crucible supporter 110 may be spaced apart from the lateral side of the standard crucible 100 by 1˜10 mm. When the distance therebetween is excessively large, the standard crucible 100 may wobble at the time the standard crucible 100 is replaced. The distance therebetween may be within an allowance error although it changes to a certain degree during the procedure of disposing the standard crucible supporter 110.

A subsidiary crucible 200 is placed on the standard crucible 100, and the subsidiary crucible 200 is surrounded by a subsidiary crucible supporter 210.

The reason for placing the subsidiary crucible 200 on the standard crucible 100 is because a silicon ingot having a high effective height can be manufactured for each work.

The subsidiary crucible 200 placed on the standard crucible 100 is made of the same material as the standard crucible 100, and the upper and lower portions thereof are opened. The raw material of the subsidiary crucible 200 may be changed depending on the kind of work.

The inclined surface 230 formed on the bottom of the subsidiary crucible 200 comes into contact with the upper surface 130 of the standard crucible 100. The length and width of the regular tetragon in the subsidiary crucible 200 are short by about 10 mm compared to those of the regular tetragon in the standard crucible 100, and thus, as shown in FIG. 1, the inner side of the subsidiary crucible 200 is disposed inwards compared to the inner side of the standard crucible 100.

Meanwhile, the inclined surface 230 of the subsidiary crucible 200 does not horizontally comes into contact with the upper surface 130 of the standard crucible 100, and is inclined at an angle of 3˜7° to a horizontal plane toward the inside of the subsidiary crucible 100 or the standard crucible 100.

According to the above configured crucible assembly, at the time of manufacturing a silicon ingot, when a silicon raw material is melted using a heater, the molten silicon raw material flows down along the wall of a crucible. In this case, since the inclined surface 230 of the subsidiary crucible 200 is inclined toward the inside of the crucible, it is possible to prevent the molten silicon raw material from flowing down the outside of the crucible. Further, since the inner side of the subsidiary crucible 200 is disposed inwards compared to the inner side of the standard crucible 100, the molten silicon raw material does not flow down the outside of the crucible, and is re-collected in the standard crucible 100, thereby manufacturing a silicon ingot having a high effective height.

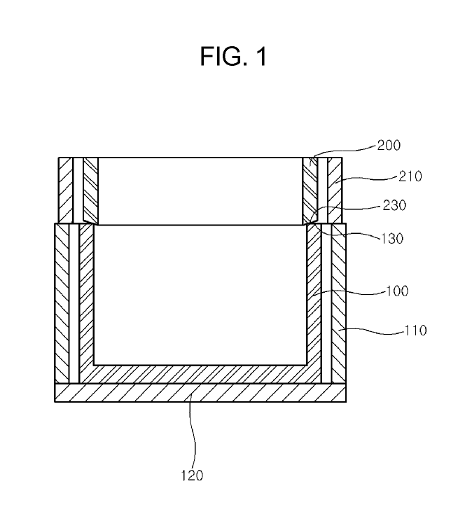

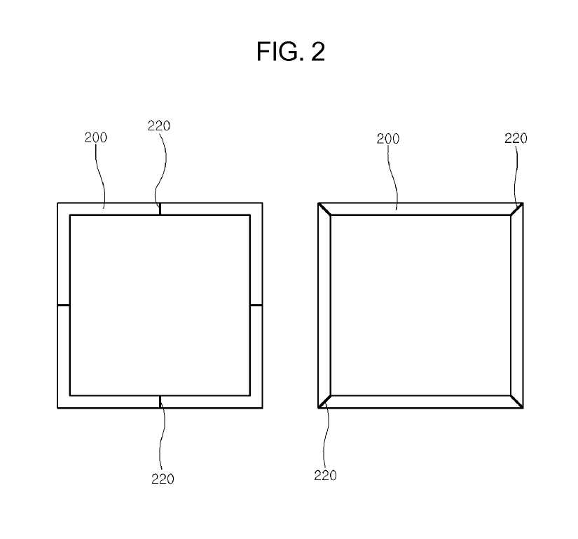

For the convenience of control and manufacture, the subsidiary crucible 200 may be an integrated crucible or a detachable crucible which can be divided into two, four or more equal parts based on the number of sectional surfaces 220 as shown in FIG. 2.

The sectional surfaces 220 of the subsidiary crucible 200 may be located at the center or corner of each lateral side of the subsidiary crucible.

The subsidiary crucible 200 can be damaged in the course of recrystallizing the molten silicon raw material. In this case, when a detachable crucible is used as the subsidiary crucible 200, only the damaged portion of the subsidiary crucible 200 can be replaced, thus reducing the cost of replacing the subsidiary crucible 200.

The height of the subsidiary crucible 200 is determined in consideration of the silicon raw material and the effective height of the manufactured silicon ingot, particularly in consideration of the size of a hot zone of a silicon ingot manufacturing apparatus including a heater and an insulation material surrounding a crucible.

The function and configuration of the subsidiary crucible supporter 210 surrounding the subsidiary crucible 200 are the same as those of the standard crucible supporter 110. In this case, the subsidiary crucible supporter 210 may not be used depending on the raw material and form of the subsidiary crucible 100 and the kind of work, but it is preferred that the subsidiary crucible supporter 210 be used for safety.

The subsidiary crucible supporter 210 is not combined and fixed with the subsidiary crucible 200, and functions to place the subsidiary crucible 200 at an original position at the time the subsidiary crucible 200 is replaced, and to prevent the pieces of the subsidiary crucible 200 from scattering outwards, the pieces being produced when the subsidiary crucible 200 is damaged in the course of cooling and recrystallizing the molten silicon raw material at the time of manufacturing a silicon ingot.

The lateral side of the subsidiary crucible supporter 210 may be spaced apart from the lateral side of the subsidiary crucible 200 by 1˜10 mm, preferably 5 mm. When the distance therebetween is excessively large or small, there is a problem in that the subsidiary crucible 200 wobbles at the time the subsidiary crucible 200 is replaced, so that the standard crucible 100 becomes detached from the subsidiary crucible 200 or the subsidiary crucible 200 is inserted into the standard crucible 100.

As described above, the present invention is advantageous in that, in a silicon ingot manufacturing apparatus, a crucible is provided thereon with a subsidiary crucible, and thus a greater amount of a silicon raw material is charged in the crucible, so that a silicon ingot having a high effective height can be manufactured for each work even when a low-density silicon raw material as well as a standard silicon raw material is used, and in that the cost required to replace a crucible, the crucible being replaced because the crucible was damaged during the procedure of cooling the molten silicon raw material for manufacturing a silicon ingot, can be reduced.

Further, the present invention is advantageous in that the inner width of a subsidiary crucible is smaller than that of a standard crucible, and the inclined surface of a subsidiary crucible coming into contact with the upper surface of a standard crucible prevents the molten silicon raw material from flowing down the outside of the standard crucible along the wall thereof to collect the molten silicon raw material in the standard crucible, thereby manufacturing a silicon ingot having a high effective height.

As described above, the terms and words used in the present specification and claims should not be interpreted as being limited to typical meanings or dictionary definitions, but should be interpreted as having meanings and concepts relevant to the technical scope of the present invention. Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A crucible assembly for manufacturing a silicon ingot, which is used in an apparatus for manufacturing a silicon ingot by refining a silicon raw material, comprising:
a standard crucible which melts a silicon raw material and whose upper portion is opened;
a standard crucible supporter which surrounds the standard crucible to position the standard crucible in place;
a subsidiary crucible including open upper and lower portions, which is provided at a bottom thereof with an inclined surface and which has length and width smaller than those of the standard crucible, the inclined surface being in contact with the upper surface of the standard crucible; and
a subsidiary crucible supporter which surrounds the subsidiary crucible to position the subsidiary crucible in place.

2. The crucible assembly for manufacturing a silicon ingot according to claim 1, wherein the inclined surface of the subsidiary crucible is inclined at an angle of 3˜7° relative to a horizontal plane downward and toward the inside of the subsidiary crucible.

3. (canceled)

4. The crucible assembly for manufacturing a silicon ingot according to claim 1, wherein the subsidiary crucible is any one of an integrated crucible and a detachable crucible.

5. The crucible assembly for manufacturing a silicon ingot according to claim 1, wherein a lateral side of the subsidiary crucible is spaced apart from a lateral side of the subsidiary crucible supporter by 1˜10 mm.
